(19) United States
(12) Patent Application Publication
(10) Pub. No.: US 2009/0297782 A1
(43) Pub. Date: Dec. 3, 2009

(54) SOFT MAGNET WITH EMBOSSED STRIPE PATTERN

(76) Inventors: Chen-Liang FAN CHIANG, Taipei county (TW); Hung-Chih WU, Taipei county (TW)

Correspondence Address: BACON & THOMAS, PLLC, 625 SLATERS LANE, FOURTH FLOOR, ALEXANDRIA, VA, 22314-1176, US

(21) Appl. No.: 12/539,096

(22) Filed: Aug. 11, 2009

Related U.S. Application Data
(63) Continuation-in-part of application No. 11/171,392, filed on Jul. 1, 2005, now abandoned.

(51) Int. Cl. B32B 3/30

(52) U.S. Cl. 428/167

(57) ABSTRACT

A soft magnet structure including a flat sheet of soft magnet. The sheet is embossed with a pattern of densely arranged stripes. The depth of the embossed stripe pattern ranges 0.1 mm and between 0.3 mm. The stripes extend in the same direction and are arranged on at least one surface of the sheet, whereby an external force or shear force is applied to the soft magnet along the stripes, the soft magnet can be torn apart in the direction of the stripes.

### BACKGROUND OF THE INVENTION

The present invention is related to an improved soft magnet structure which is embossed with a pattern of densely arranged stripes. The stripes extend in the same direction, whereby the soft magnet can be manually torn apart in the direction of the stripes without using any tool.

A soft magnet is generally a complex sheet or block material made from mixture of magnetizable powder, such as ferric oxide powder, and rubber or plastic. The material is at least once magnetized in such a manner that pulse current passes through a magnetic conducting disc with different magnetizing divisions. The magnetic conducting disc serves to induce magnetic poles with different polarities on the surface of the material. Accordingly, a soft magnet with flexibility and magnetic attraction is achieved for attracting a magnetically attractable article (such as an iron material). The soft magnet can be used to make decorative magnetic block (sheet), magnetic clip, magnetic paper holder or other locating members for fixing papers. Recently, a very thin soft magnetic sheet has been developed for wider application.

In the manufacturing procedure, the soft magnet must be first molded and magnetized and then cut into a product.

The conventional custom soft magnet is divided into pieces by cutting. The thin sheet-type soft magnet must be cut by means of a cutting tool. Especially, in the case that it is necessary to cut the soft magnet by a long length, a precise measurement and locating platform are required for the cutting operation. In a modularized soft magnet production line, the above measurement and cutting operation complicate the manufacturing procedure and increase the manufacturing cost. Therefore, the applicant has simplified the texture and structure of the soft magnet to facilitate the cutting operation.

### SUMMARY OF THE INVENTION

It is therefore a primary object of the present invention to provide an improved soft magnet structure including flat sheet of soft magnet. The flat sheet is embossed with a pattern of densely arranged stripes. The stripes extend in the same direction and are arranged on at least one surface of the flat sheet. The depth of the embossed stripe pattern ranges between 0.1 mm and 0.3 mm, when an external force or shear force is applied to the soft magnet along the stripes, the soft magnet can be easily torn apart in the direction of the stripes.

The present invention can be best understood through the following description and accompanying drawings wherein:

### BRIEF DESCRIPTION OF THE DRAWINGS

FIG. 1 is a perspective view of the present invention;

FIG. 2A shows that the flat sheet is embossed with longitudinal stripes by an embossing roller;

FIG. 2B shows that the flat sheet is embossed with transverse stripes by an embossing roller;

FIG. 3A shows a pattern of the embossed stripes of the soft magnet of the present invention;

FIG. 3B shows another pattern of the embossed stripes of the soft magnet of the present invention;

FIG. 3C shows a dotted pattern of the soft magnet of the present invention;

FIG. 4 shows that the soft magnet embossed with the stripes is torn apart; and

FIG. 5 is a sectional view showing the stripes of the soft magnet of the present invention.

### DETAILED DESCRIPTION OF THE PREFERRED EMBODIMENTS

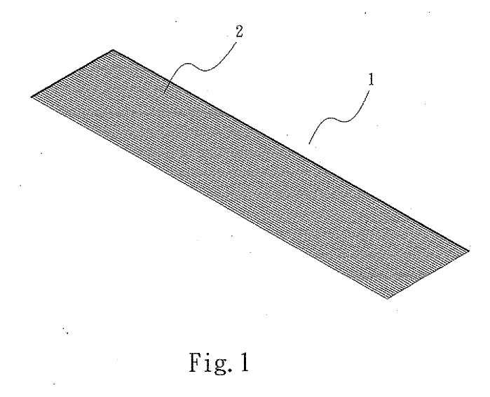

Please refer to FIG. 1. The flat sheet 1 of the soft magnet of the present invention is embossed with a pattern 2 of densely arranged stripes or lines. The stripes extend in the same direction at equal intervals or unequal intervals. In this embodiment, the embossed stripe pattern 2 has multiple parallel lines and channels with a certain depth. The said certain depth ranges between 0.1 mm and 0.3 mm. The channels are formed on at least one surface of the sheet 1.

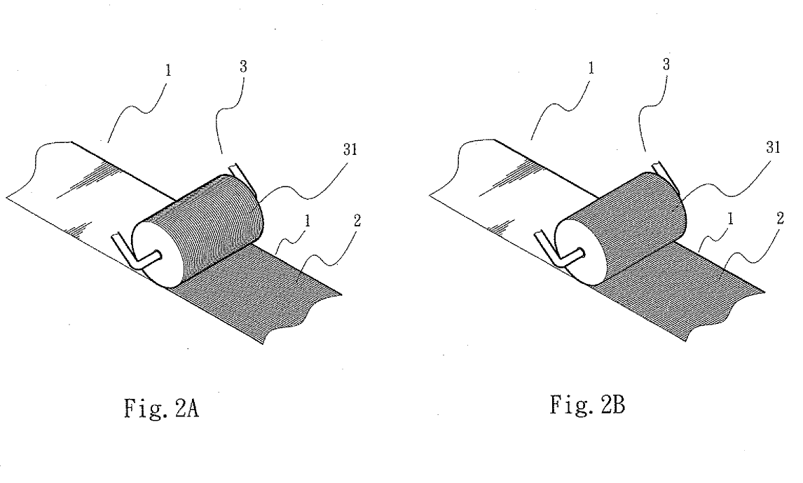

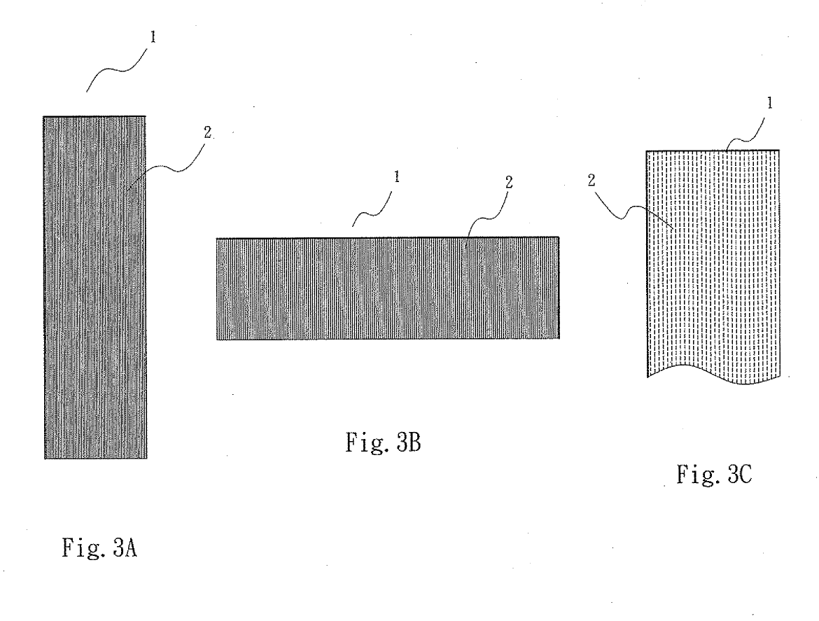

FIGS. 2A and 2B show an embossing machine for embossing the soft magnet. The circumferential face of a roller 3 is formed with densely arranged stripe-like blades 31 extending in the same direction. When the sheet 1 of the soft magnet passes through the roller 3, the roller 3 embosses the sheet with the stripe pattern 2. The arrangement pattern of the stripe pattern 2 is determined by the pattern of the blades 31. After embossing, the sheet 1 is formed with longitudinally arranged stripe pattern (FIG. 3A), transversely arranged stripe pattern (FIG. 3B), dotted pattern (FIG. 3C) or the like.

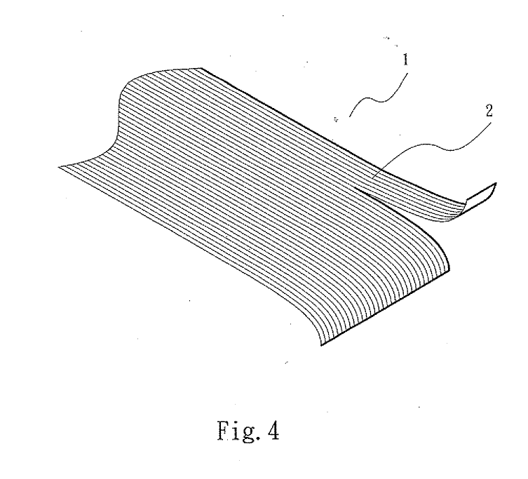

Referring to FIG. 4, the soft magnet with the embossed stripe pattern 2 can be easily manually torn apart in the direction of the stripe pattern 2. Alternatively, the soft magnet with the embossed stripe pattern 2 can be directly torn apart by a manufacturer with an auxiliary tool (such as a ruler or a blade) in the direction of the stripe pattern 2 according to necessary size and shape. Therefore, it is unnecessary to previously measure the soft magnet before cutting the soft magnet. In addition, the soft magnet can be torn into pieces without using any cutting tool.

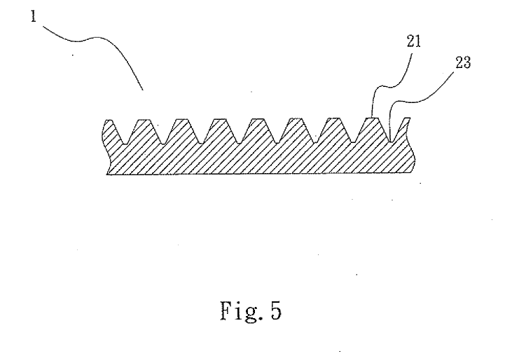

FIG. 5 is an enlarged sectional view of the soft magnet. FIG. 5 shows that the embossed stripe pattern 2 is formed as a saw-tooth structure on the sheet 1. The embossed stripe pattern 2 includes ridge sections 21 and trough sections 23 between the adjacent ridge sections 21. The thickness of the sheet 1 is thinned at the trough sections 23. In the preferred embodiment, in which the depth of the embossed stripe pattern 2 is 0.2 mm, and the thickness of the trough sections 23 is 0.5 mm, so the trough section 23 can be formed a fragile part, whereby the soft magnet can be torn apart by external force or shear force. The ridge and trough sections 21 and 23 may be spaced at substantially equal intervals.

The above embodiments are only used to illustrate the present invention, not intended to limit the scope thereof. Many modifications of the above embodiments can be made without departing from the spirit of the present invention.

What is claimed is:

1. A soft magnet structure comprising a flat sheet of soft magnet, the flat sheet being embossed with a layer having alternating ridges and troughs, the ridges abutting the troughs, the ridges and troughs extending in the same direction and being densely arranged as parallel lines spaced at substantially equal intervals to extend across at least one surface of the flat sheet, the depth of the embossed stripe pattern ranges between 0.1 mm and 0.3 mm, whereby when an external force or shear force is applied to the soft magnet along the troughs, the soft magnet can be torn apart in the direction of the troughs

2. The soft magnet structure as claimed in claim 1, wherein the troughs are longitudinally arranged or transversely arranged on the flat sheet.

3. The soft magnet structure as claimed in claim 1, wherein the embossed stripe pattern of the flat sheet is a saw-tooth structure.

4. The soft magnet structure as claimed in claim 2, wherein the embossed stripe pattern of the flat sheet is a saw-tooth structure.

5. A soft magnet structure comprising a plane blank flat sheet of soft magnet, the plane blank flat sheet being arranged with a pattern of dotted stripes, every dotted stripes abutting another dotted stripes; the dotted stripes extending in the same direction and being densely arranged as parallel lines spaced at substantially equal intervals to extend across at lease one surface of the plane blank flat sheet, whereby when an external force or shear force is applied to the soft magnet along the troughs, the soft magnet can be torn apart in the direction of the dotted stripes.
